(19) United States
(12) Patent Application Publication
(10) Pub. No.: US 2002/0067506 A1
(43) Pub. Date: Jun. 6, 2002

(54) Image compression device and method

(76) Inventor: Byeong-Soon Ryu, Daejeon-city (KR)

Correspondence Address: Daniel F. Drexler, CANTOR COLBURN LLP, 55 Griffin Road South, Bloomfield, CT, 06002, US

(21) Appl. No.: 09/993,195

(22) Filed: Nov. 26, 2001

(30) Foreign Application Priority Data
Dec. 1, 2000 (KR) 2000-72297

(51) Int. Cl. G06F 15/00; B41J 1/00

(52) U.S. Cl. 358/1.15

(57) ABSTRACT

The present invention discloses an image compression device and method employing a prior knowledge to split an image inputted from a camera or other input media into at least two hierarchical images, and compressing each split image according to each corresponding hierarchy, to improve an image compression performance, while the image compression device of the present invention comprises an image receiver for storing image data inputted from a video camera or other image monitoring device, a knowledge database for storing the image data to a database in an appropriate form by applying a prior knowledge, a hierarchical separator for splitting each of the input image in the database into several hierarchical images respectively by applying a storage information in the knowledge database, a hierarchical image storage for storing each of the split hierarchical images respectively, a hierarchical image compressor for compressing each of the split hierarchical images, a compressed data storage for storing the compressed data, a decoder for decompressing and restoring the compressed data, a predicted decompression image storage for storing the restored data, and a knowledge database controller for applying the predicted decompressed image stored in the predicted decompression image storage, to manage and update information of the knowledge database.

### CROSS REFERENCE

This application claims the benefit of Korean Patent Application No. 2000-72297, filed on Dec. 1, 2000, under 35 U.S.C. §119, the entirety of which is hereby incorporated by reference.

### BACKGROUND OF THE INVENTION

1. Field of the Invention

The present invention refers to an image compression device and a method employing a prior knowledge to split an image inputted from a camera or other image media into at least two hierarchical images, and compressing each split image according to each corresponding hierarchy. Therefore, the image compression device and method according to the present invention can improve an image compression performance.

2. Description of the Related Art

The recent multi media developments allow visual information to be treated in various fields, such as mobile telecommunications and digital video recorder. However, the data size of the visual information is so huge that a large storing space or a network with a large bandwidth is required to treat the visual information.

Because too much expense is required to construct such a large storing space or a network with a large bandwidth, there are attempts for storing and transmitting compressed images to reduce the expense.

There are several standard methods for compressing images such as Joint Photographic Experts Group (JPEG), Moving Picture Experts Group (MPEG), H.261 and H.263, and there are also numerous methods revising slightly those standard methods.

However, the compression method established as the standard is largely classified into two methods. One of the two methods is a static image compression method compressing respective image one by one. In other words, the static image compression method performs compressing image by not applying correlations between the images, but applying Discrete Cosine Transform (DCT) or Wavelet Transform.

The other method is a moving picture compression method applying correlations between series of images to accomplish higher compression performance. In other words, the moving picture compression method utilizes moving information mainly extracted from time-sequential images.

The conventional compression method illustrated in the above statements compresses images to simple numeric transform or utilizes moving of objects only. Therefore, the conventional compression method is not optimal to specific fields, but to general fields.

As a result, such restrictions, applied to general fields, lose an advantage that a prior knowledge for a specific field can be used in compressing images in the specific field.

In other words, the visual information includes various complicated objects. For examples, in the case of digital image monitoring system, the inputted images comprise a passageway, a door, a chair, and a passenger.

Accordingly, those objects can be divided into several groups according to predetermined standards. According to mobility standards, those objects in the above examples can be classified into three groups, wherein one group includes the passageway and the wall, another group includes the door and the chair, and a third group includes the passengers. In other point of views, those objects in the above examples can be classified into five groups, when each of the above objects is considered as each group respectively.

Grouping images means that the compression performance can be improved by applying correlations between the information to each of the groups and the objects belong to the corresponding group when the images are compressed.

However, the images can be grouped into various types according to the classification standards. The best grouping method in general can not be decided because a best optimizing grouping method in a specific field can not have equal compression performance in other fields.

Therefore, it is important to apply a prior knowledge to group images efficiently.

For example, most of the digital images monitoring systems observe a predetermined place for a long period. Therefore, information about changes of the digital images monitoring system in itself, such as mobility of a camera and a present time, can easily be recognized even though the inputted image is changed.

Accordingly, by classifying the images into at least one group, such as changeable images, unchanged images and images changing only specified characteristics, more efficient compression performance can be obtained. Particularly, by applying preliminary knowledge, such as mobility of a camera and a present time, maximized compression effects can be obtained.

### SUMMARY OF THE INVENTION

In order to achieve the above object, the preferred embodiments of the present invention provide an image compression device comprising an image receiver for storing image data inputted from a video camera or other image media, a knowledge database for storing the image data to a database in an appropriate form by applying a preliminary knowledge, a hierarchical separator for splitting each of the input imageinto several hierarchical images respectively by applying an information stored in the knowledge database, a hierarchical image storage for storing each of the split hierarchical images respectively, a hierarchical image compressor for compressing each of the split hierarchical images, a compressed data storage for storing the compressed data in the hierarchical image compressor, a decoder decompressing the compressed data, a predicted decompression image storage for storing the restored data in the decoder, and a knowledge database controller for applying the predicted decompressed image in the predicted decompression image storage, to manage and update information of the knowledge database.

The another object of the present invention provides an image compression method comprising steps of constructing a knowledge database by applying preliminary knowledge to the inputted image, storing temporarily the inputted image to a memory, updating the knowledge database about the inputted image, splitting the inputted image into hierarchical images by applying the knowledge database, compressing the split hierarchical image data according to the corresponding split hierarchies respectively, generating the compressed data by merging the compressed split data, decoding the compressed data in the above step to generate a restored image, and updating the restored image in the knowledge database.

The step of splitting the inputted image into hierarchical images may includes spliting the inputted image into at least two hierarchical images containing an image with a background image and an image without the background image.

The image without the background image is split into a changed image and an unchanged image.

The step of updating the restored image in the knowledge database is performed such that the intermediate background image substitutes for the inputted image and initializes a grade integer to ‘0’ where the difference between the block of the inputted image and the block corresponding to the intermediate background image is greater than the threshold value, and that the intermediate background image increases the grade integer by ‘1’ where the difference between the block of the inputted image and the block corresponding to the intermediate background image is less than the threshold value, and that the background image updates the image of the blocks where the number of the blocks respectively having a grade integer of over a predetermined value is greater than the threshold value.

### BRIEF DESCRIPTION OF THE DRAWINGS

For a more complete understanding of the present invention and the advantages thereof, reference is now made to the following descriptions taken in conjunction with the accompanying drawings, in which like reference numerals denote like parts, and in which:

FIG. 1 is a block diagram of an image compression device according to a referred embodiment of the present invention;

FIG. 2a and FIG. 2b are flow charts of an image compression method according to the preferred embodiment of the present invention; and

FIG. 3 is an example drawing illustrating splitting an image with a background image according to the preferred embodiment of the present invention.

### DETAILED DESCRIPTION OF PREFFERED EMBODIMENTS

Reference will now be made in detail to preferred embodiments of the present invention, example of which is illustrated in the accompanying drawings.

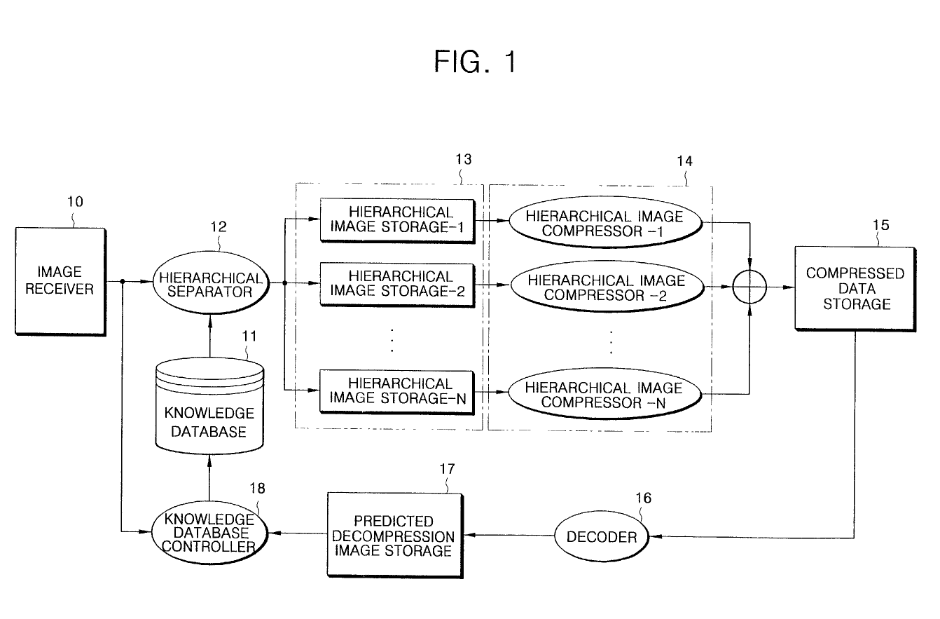

FIG. 1 is a block diagram of an image compression device according to the preferred embodiments of the present invention. The image compression device according to the preferred embodiments of the present invention comprises an image receiver 10, a knowledge database 11, a hierarchical separator 12, a hierarchical image storage 13, a hierarchical image compressor 14, a compressed data storage 15, a decoder16, a predicted decompression image storage 17, and a knowledge database controller 18.

In this case, the image receiver 10 stores image data inputted from a video camera or other image media, and the knowledge database 11 stores the image data to a database in an appropriate form by applying a prior knowledge. The hierarchical separator 12 splits each input image into at least two hierarchical images respectively by applying the information stored in the knowledge database, and the hierarchical image storage 13 stores each of the split hierarchical images, respectively. Additionally, the hierarchical image compressor 14 compresses each of the split hierarchical images, and the compressed data storage 15 stores the compressed data in the hierarchical image compressor 14 merged into one data stream. The decoder16 or decompresses the compressed data, and the predicted decompression image storage 17 stores the decompressed data in the decoder 16. Finally, the knowledge database controller 18 applies the decompressed image in the predicted decompression image storage 17, an inputted image, and an external input, to manage and update information of the knowledge database 11.

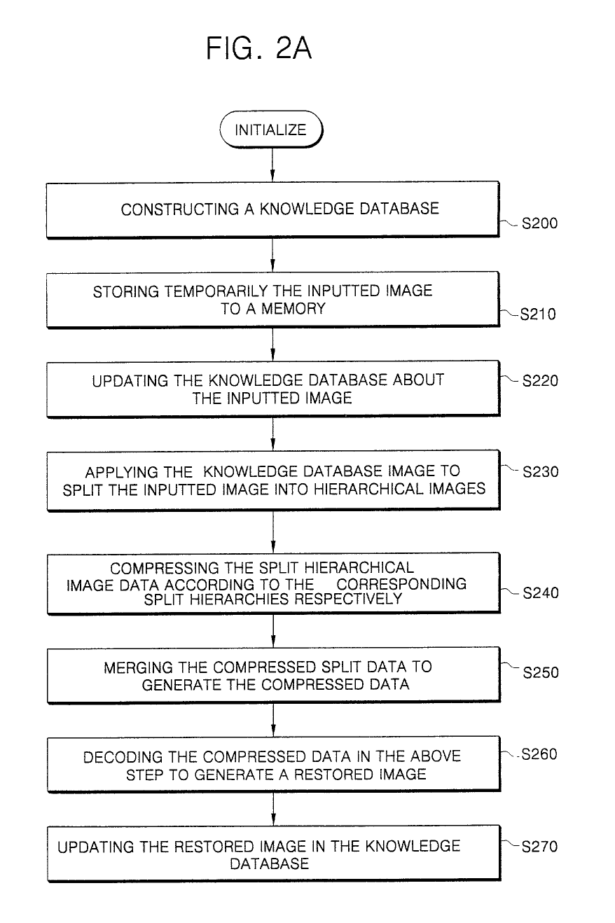

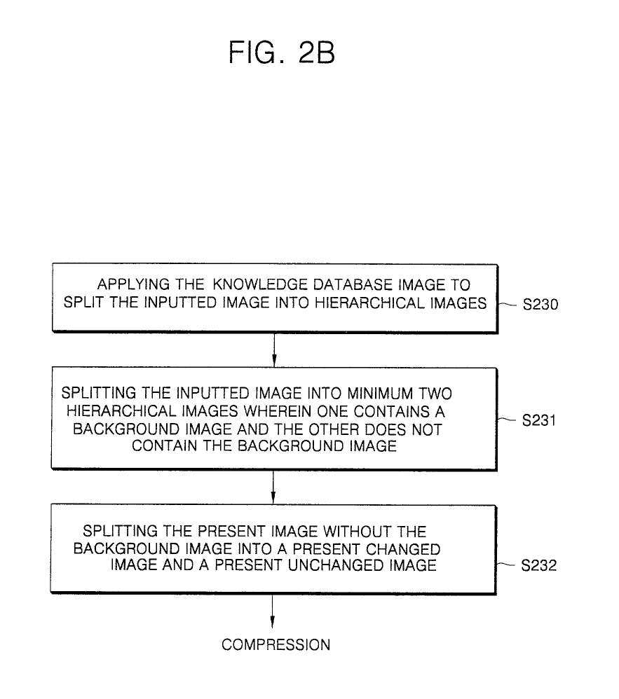

FIG. 2a and FIG. 2b are flow charts of an image compression method according to the preferred embodiments of the present invention. The image compression method according to the preferred embodiments of the present invention comprises steps of constructing a knowledge database by applying a prior knowledge to the inputted image (S200), storing temporarily the inputted image to a memory (S210), updating the knowledge database about the inputted image (S220), splitting the inputted image into hierarchical images by applying the knowledge database (S230), compressing the split hierarchical image data according to the corresponding split hierarchies, respectively (S240), generating the compressed data by merging the compressed split data (S250), decoding the compressed data in the above step to generate a restored image (S260), and updating the restored image in the knowledge database (S270).

As shown in FIG. 2b, the step of splitting the inputted image into the hierarchical images (S230) comprises a splitting step (S231) splitting the inputted image into minimum two hierarchical images wherein one contains a background image and the other does not contain the background image.

The step of splitting the inputted image into hierarchical images also includes a step (S232) splitting the present image without the background image into a present changed image and a present unchanged image while comparing the present image without the background image with the previous image without the background image.

In more detail, as shown in FIG. 2a, an embodiment of the present invention constructs an initial knowledge database memorizing a prior knowledge necessary to split the inputted image into hierarchical images (S200).

Sequentially, an additional device converts an analog signal inputted from a video camera or other devices outputting the same signals as the video camera into a digital signal, and the converted digital signal is temporarily stored in a memory. In other way, the knowledge database controller 18 directly receives digital signals from a device outputting the digital signals, and temporarily stores the digital signals (S210).

In this case, a temporary storage of the digital signals to the knowledge database controller 18 includes pre-processes such as color coordinate conversion and scaling.

As a following step, the knowledge database controller 18 analyzes and compares the inputted image with the information in the knowledge database 11 to update the information of the knowledge database 21 to fit on the changed situations (S220). In this time, the knowledge database 21 can have an arbitrary configuration according to hierarchical splitting methods.

Accordingly, when images are inputted from the video camera or the other devices outputting the same type of signals as the video camera through the image receiver 10, the hierarchical separator 12 splits the inputted image data. In detail, the hierarchical separator 12 based upon the data previously constructed in the knowledge database 11, splits the inputted image into several hierarchical images (S230).

As shown in FIG. 2b, the hierarchical separation splits the inputted image into at least two hierarchical images, for example an image with a background image and an image without the background image (an intermediate background image).

In other words, the hierarchical separation for the inputted image separately stores the present background image and an intermediate background image for updating the present background image (S23 1). In this case, the image is divided into a predetermined size (for example, a small unit block of 8 x 8), and each blocks stores the information for the background image.

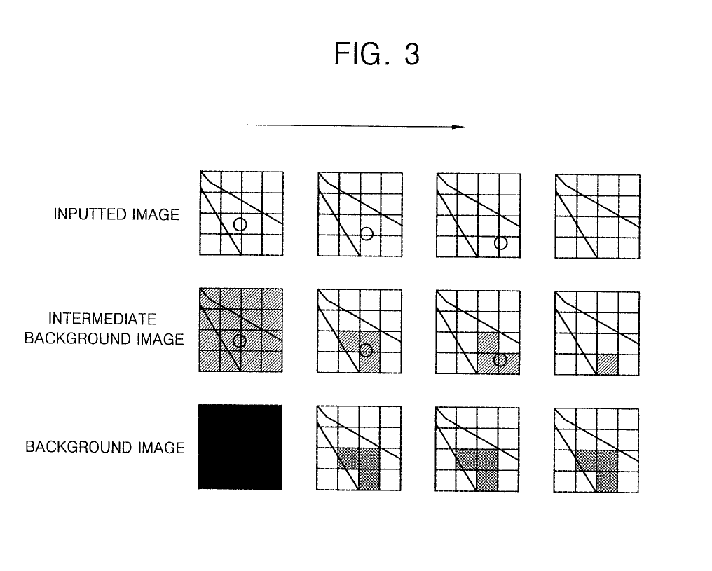

As shown in FIG. 3, the intermediate background image and the background image are updated when the image is sequentially inputted. In this case, the background image and the intermediate background image are designated to nothing when the background image and the intermediate background image are initialized.

In the state of storing the background image and the intermediate background image, the knowledge database controller 18 compares the inputted image with the background image in unit of each blocks (a block according to the circle moving). When the difference according to the comparison is over a predetermined threshold value, the inputted image is compared again with the intermediate image.

Therefore, when the difference between the block of the inputted image and the block corresponding to the intermediate background image is over the threshold value, the intermediate background image substitutes for the inputted image and initializes a grade integer to ‘0’. In other case, when the difference between the block of the inputted image and the block corresponding to the intermediate background image is less than the threshold value, the intermediate background image increases the grade integer by ‘1’. If the number of the blocks respectively having a grade integer of over a predetermined value is over the threshold value, the background image updates the image of the blocks.

When a camera is connected to an electric rotator, the knowledge database controller 18 detects the order for operating the electric rotator to initialize the background image and the intermediate background image.

Additionally, after the knowledge database is updated by applying the inputted image and an external input, the hierarchical separator 12 compares the inputted image with the background image, and splits the inputted image into the hierarchical image with the background image and the hierarchical image without the background image.

Each of the inputted images may be split into at least two hierarchical images in the hierarchical separator 12 and each of the split images is stored in the corresponding each of the hierarchical image storages 13. Additionally, each of the hierarchical image compressors 14 compresses each of the hierarchical stored image data by applying appropriate compression methods, such as a JPEG or a MPEG (S240). In this case, the hierarchical image compression can apply various compression methods and the same compression method can be applied to various steps.

Sequentially, the hierarchical compressed image data in the hierarchical image compressor 14 are merged in the compressed data storage 15 to generate the compressed image data (S250). Therefore, the data generated in each of the hierarchical image compressors 14 are merged to one data stream.

Sequentially, the decoder16 decompresses and restores the compressed image data comprising one data stream in the compressed data storage 15 (S260), and the decompressed and restored image data generates a restored image in the predicted decompression image storage 17. The restored image data updates the knowledge database 11 through the knowledge database controller 18 so that the knowledge database controller 18 applies the difference information between the inputted image and the compressed image to the images inputted thereafter.

As described in the above statements, the preferred embodiments according to the present invention construct a knowledge database according to a prior knowledge to the inputted image. After that, the preferred embodiments according to the present invention compare the inputted image with the background image when the inputted image are split into hierarchical images by applying the knowledge database in the state of updating the knowledge database to the inputted image. Finally, the preferred embodiments of the present invention compress the hierarchical images after the background images are split into a hierarchical image with the background image and a hierarchical image without the background image. As a result, the image compression performance can be improved.

While the invention has been particularly shown and described with reference to preferred embodiments thereof, it will be understood by those skilled in the art that the foregoing and other changes in form and details may be made therein without departing from the spirit and scope of the invention.

What is claimed is:

1. An image compression device comprising:
an image receiver for storing image data inputted from various kinds of image media;
a knowledge database for storing the image data to a database in an appropriate form by applying a prior knowledge;
a hierarchical separator for splitting each of input image into several hierarchical images, respectively, by applying an information stored in the knowledge database;
a hierarchical image storage for storing each of the split hierarchical images;
a hierarchical image compressor for compressing each of the split hierarchical images;
a compressed data storage for storing the compressed data;
a decoder for decompressing and restoring the compressed data;
a predicted decompression image storage for storing the restored data; and
a knowledge database controller for applying the predicted decompressed image stored in the predicted decompression image storage in order to manage and update information of the knowledge database.

2. An image compression method comprising:
a step of constructing a knowledge database by applying a prior knowledge to an inputted image;
a step of storing temporarily the inputted image to a memory;
a step of updating the knowledge database about the inputted image;
a step of splitting the inputted image into hierarchical images by applying the knowledge database;
a step of compressing the split hierarchical image data according to the corresponding split hierarchies, respectively;
a step of generating a compressed data by merging the compressed split hierarchical image data;
a step of decoding the compressed data to generate a restored image; and
a step of updating the restored image in the knowledge database.

3. The image compression method according to claim 2, wherein the step of splitting the inputted image into hierarchical images comprises splitting the inputted image into at least two hierarchical images containing an image with a background image and an image without the background image.

4. The image compression method according to claim 3, wherein the image without the background image is split into a changed image and an unchanged image.

5. The image compression method according to claim 2, wherein the step of updating the restored image in the knowledge database is performed such that an intermediate background image substitutes for the inputted image and initializes a grade integer to ‘0’ where a difference between a block of the inputted image and a block corresponding to the intermediate background image is greater than a threshold value, and that the intermediate background image increases the grade integer by ‘1’ where the difference between the block of the inputted image and the block corresponding to the intermediate background image is less than the threshold value, and that the background image updates the image of the blocks where the number of the blocks respectively having a grade integer of over a predetermined value is greater than the threshold value.
